(19) United States
(12) Patent Application Publication
(10) Pub. No.: US 2007/0031692 A1
(43) Pub. Date: Feb. 8, 2007

(54) Starch compatibility of paper coating compounds

(75) Inventors: Oliver Birkert, Mannheim (DE); Ingolf Kuehn, Schmerbach (DE); Johannes Jan-Bessel Minderhoud, Limburgerhof (DE); Jyrki Mikael Nikkanen, Kouvola (FI)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/571,126

(22) PCT Filed: Sep. 8, 2004
(86) PCT No.: PCT/EP04/10019

§ 371 Date: Mar. 9, 2006

(30) Foreign Application Priority Data
Sep. 12, 2003 (DE) 103 42 517.9

(51) Int. Cl. B32B 27/10

(52) U.S. Cl. 428/511; 524/500

(57) ABSTRACT

A mixture of A) an aqueous polymer dispersion (emulsion polymer for short) obtainable by emulsion polymerization and B) a polymer which is soluble in water (at 20° C., 1 bar), obtainable by free radical polymerization and composed of at least 5% by weight of ethylenically unsaturated acids is used in paper coating slips.

The present invention relates to the use of a mixture of
A) an aqueous polymer dispersion (emulsion polymer for short) obtainable by emulsion polymerization and
B) a polymer which is soluble in water (at 20° C, 1 bar), obtainable by free radical polymerization and composed of at least 5% by weight of ethylenically unsaturated acids
   in paper coating slips.

Paper coating slips contain binder, white pigments and assistants, e.g. thickeners.

Suitable binders are both synthetic polymers, for example polymer dispersions based on butadiene and styrene or on alkyl acrylates, and naturally occurring polymers, e.g. starch.

In particular, mixtures of different binders are also used. In the case of mixtures, incompatibilities between the binders may occur, evident, for example, from the increase in viscosity and/or a deterioration in the performance characteristics. In particular, such incompatibilities are observed in the case of mixtures of synthetic polymers and starch.

Such incompatibilities are often also observed in the presence of paper coating slips which have been obtained as waste in the coating process and worked up again.

It is an object of the present invention to avoid incompatibilities when using binder mixtures.

We have found that this object is achieved by the use defined above. We have also found a process for the preparation of paper coating slips, and paper coating slips which contain binder mixtures.

According to the invention, the mixture contains an emulsion polymer A) and a water-soluble polymer B).

The emulsion polymer preferably comprises at least 40, especially at least 60, particularly preferably at least 80, % by weight of main monomers.

The main monomers are selected from C₁-C₂₀-alkyl (meth)acrylates, vinyl esters of carboxylic acids of up to 20 carbon atoms, vinylaromatics of up to 20 carbon atoms, ethylenically unsaturated nitriles, vinyl halides, vinyl ethers of alcohols of 1 to 10 carbon atoms, aliphatic hydrocarbons having 2 to 8 carbon atoms and one or two double bonds and mixtures of these monomers.

Examples are alkyl (meth)acrylates having a C₁-C₁₀-alkyl radical, such as methyl methacrylate, methyl acrylate, n-butyl acrylate, ethyl acrylate and 2-ethylhexyl acrylate.

In particular, mixtures of the alkyl (meth)acrylates are also suitable.

Vinyl esters of carboxylic acids of 1 to 20 carbon atoms are, for example, vinyl laurate, vinyl stearate, vinyl propionate, vinyl versatate and vinyl acetate.

Suitable vinylaromatic compounds are vinyltoluene, α- and p-methylstyrene, α-butylstyrene, 4-n-butylstyrene, 4-n-decylstyrene and preferably styrene. Examples of nitriles are acrylonitrile and methacrylonitrile.

The vinyl halides are ethylenically unsaturated compounds substituted by chlorine, fluorine or bromine, preferably vinyl chloride and vinylidene chloride.

Examples of vinyl ethers are vinyl methyl ether and vinyl isobutyl ether. Vinyl ethers of alcohols of 1 to 4 carbon atoms are preferred.

Examples of hydrocarbons having 2 to 8 carbon atoms and one or two olefinic double bonds are ethylene, propylene, butadiene, isoprene and chloroprene.

Preferred main monomers are C₁-C₁₀-alkyl (meth)acrylates and mixtures of the alkyl (meth)acrylates of the vinylaromatics, in particular styrene, or hydrocarbons having 2 double bonds, in particular butadiene, or mixtures of such hydrocarbons with vinylaromatics, in particular styrene.

In the case of mixtures of aliphatic hydrocarbons (in particular butadiene) with vinylaromatics (in particular styrene), the ratio may be, for example, from 10:90 to 90: 10, in particular from 20:80 to 80:20.

Particularly preferred main monomers are butadiene and the above mixtures of butadiene and styrene.

In addition to the main monomers, the polymer may contain further monomers, for example monomers having carboxyl, sulfo or phosphonic acid groups. Carboxyl groups are preferred. Examples are acrylic acid, methacrylic acid, itaconic acid, maleic acid and fumaric acid. The content of ethylenically unsaturated acids in the emulsion polymer is in general less than 5% by weight.

Further monomers are, for example, also hydroxyl-containing monomers, in particular C₁-C₁₀-hydroxyalkyl (meth)acrylates, or amides, such as (meth)acrylamide.

In a preferred embodiment, the preparation of the polymers is effected by emulsion polymerization, and the polymer is therefore an emulsion polymer.

However, the preparation can also be carried out, for example, by solution polymerization and subsequent dispersing in water.

In the emulsion polymerization, ionic and/or nonionic emulsifiers and/or protective colloids or stabilizers may be used as surface-active compounds.

The surface-active substance is usually used in amounts of from 0.1 to 10% by weight, based on the monomers to be polymerized.

Water-soluble initiators for the emulsion polymerization are, for example, ammonium and alkali metal salts of peroxodisulfuric acid, e.g. sodium peroxodisulfate, hydrogen peroxide or organic peroxides, e.g. tert-butyl hydroperoxide.

Reduction-oxidation (redox) initiator systems are also suitable.

The amount of the initiators is in general from 0.1 to 10, preferably from 0.5 to 5, % by weight, based on the monomers to be polymerized. It is also possible to use a plurality of different initiators in the emulsion polymerization.

Regulators may be used in the polymerization, for example in amounts of from 0 to 3 parts by weight, based on 100 parts by weight of the monomers to be polymerized, the molar mass being reduced by said regulators. For example, compounds having a thiol group, such as tert-butyl mercaptan, ethylacryloyl thioglycolate, mercaptoethynol, mercaptopropyltrimethoxysilane or tert-dodecyl mercaptan, are suitable.

The emulsion polymerization is effected as a rule at from 30 to 130° C., preferably from 50 to 100° C. The polymerization medium may consist either only of water or of a mixture of water and liquids miscible therewith, such as methanol. Preferably, only water is used. The emulsion polymerization can be carried out either as a batch process or in the form of a feed process, including the step or gradient procedure. The feed process in which a part of the polymerization batch is initially taken, heated to the polymerization temperature and partially polymerized and then the remainder of the polymerization batch is fed to the polymerization zone continuously, stepwise or with superposition of a concentration gradient while maintaining the polymerization, usually via a plurality of spatially separated feeds, one or more of which contain the monomers in pure or in emulsified form, is preferred. In the polymerization, a polymer seed may also be initially taken, for example for better adjustment of the particle size.

The manner in which the initiator is added to the polymerization vessel in the course of the free radical aqueous emulsion polymerization is known to an average person skilled in the art. It may either be completely initially taken in the polymerization vessel or used continuously or stepwise at the rate of its consumption in the course of the free radical aqueous emulsion polymerization. Specifically, this depends on the chemical nature of the initiator system as well as on the polymerization temperature. Preferably, a part is initially taken and the remainder is fed to the polymerization zone at the rate of consumption.

For removal of the residual monomers, initiator is usually also added after the end of the actual emulsion polymerization, i.e. after a conversion of the monomers of at least 95%.

In the feed process, the individual components can be added to the reactor from above, at the side or from below through the reactor bottom.

In the emulsion polymerization, aqueous dispersions of the polymer, as a rule having solids contents of from 15 to 75, preferably from 40 to 75, % by weight are obtained.

The polymer B) contained in the mixture is soluble in water at 20° C., 1 bar. In this context, water solubility is to be understood as meaning that at least 100 g of polymer are soluble in 1 liter of water.

Preferably at least 200, in particular at least 300, particularly preferably at least 500, g of polymer B) are soluble in 1 liter of water.

Polymer B) is preferably composed of ethylenically unsaturated compounds capable of free radical polymerization and is preferably obtained by free radical polymerization.

Polymer B) is preferably composed of at least 10, in particular at least 30, particularly preferably at least 50, % by weight of ethylenically unsaturated acids, in particular carboxylic acids.

Suitable carboxylic acids are, for example, acrylic acid, methacrylic acid, itaconic acid or maleic acid or fumaric acid.

In addition to the ethylenically unsaturated acids, polymer B) may contain other ethylenically unsaturated compounds as comonomers. The abovementioned main monomers and further monomers are particularly suitable.

Preferably at least some of the acid groups of the polymer B) may also be present in the form of salts, for example alkali metal or ammonium salts, particularly preferably in the form of the sodium salt. In particular, at least 10, particularly preferably at least 30, very particularly preferably at least 50, mol % of the acid groups are present in the form of a salt.

Polymer B) preferably has a number average molecular weight Mn of from 500 to 5 000, particularly preferably from 1 000 to 3 000, g/mol, measured by gel permeation chromatography.

Preferred polymers B) are, for example, polyacrylic acid, polymethacrylic acid and the salts thereof.

The mixture of emulsion polymer A) and polymer B) can preferably be prepared in a simple manner by dissolving polymer B) in the polymer dispersion A), obtained by emulsion polymerization.

In another preferred embodiment, the emulsion polymerization of A) can be effected in the presence of B) itself.

Polymer B) can be added, for example, during the emulsion polymerization or can even be dissolved in the water used before the beginning of the emulsion polymerization.

The amount of polymer B) used is preferably from 0.01 to 10 parts by weight, particularly preferably at least 0. 1, in particular at least 0.3, part by weight and not more than 7, in particular not more than 5, parts by weight, based on 100 parts by weight of polymer A).

Particularly preferably, polymer B) is added to the aqueous dispersion of A) after removal of volatile residual monomers (deodorization) is complete.

According to the invention, the mixture is used as a component of paper coating slips.

Paper coating slips contain, as components, in particular
a) one or more binders
b) if required, a thickener
c) if required, a fluorescent or phosphorescent dye, in particular as an optical brightener
d) pigments or fillers
e) further assistants, for example leveling agents or other dyes.

It has proven advantageous to combine binders of different compositions.

In addition to synthetic polymers, such as the above emulsion polymers, natural polymers, such as starch, are also suitable.

The mixture can be used as a sole binder in paper coating slips. In particular, however, the mixture can also be combined with other binders. It is a particular advantage of the mixture that incompatibilities with other binders do not occur or occur to a reduced extent.

In particular, the mixture has good compatibility with starch.

The mixture is therefore particularly suitable for paper coating slips which contain starch.

In this context, starch is to be understood as meaning any natural, modified or degraded starch. Natural starches may consist of amylose, amylopectin or mixtures thereof. Modified starches may be oxidized starch, starch esters or starch ethers.

The molecular weight of the starch can be reduced by hydrolysis (degraded starch). Suitable degradation products are oligosaccharides or dextrins.

Preferred starches are cereal, corn and potato starch. Cereal and corn starch are particularly preferred, and cereal starch is very particularly preferred.

Suitable thickeners b) in addition to synthetic polymers are in particular celluloses, preferably carboxymethylcellulose.

The pigment or filler d) is in general a white pigment, e.g. barium sulfate, calcium carbonate, calcium sulfoaluminate, kaolin, talc, titanium dioxide, zinc oxide, chalk or coating clay.

The paper coating slips contain binders preferably in amounts of from 1 to 5, particularly preferably from 5 to 20, parts by weight of binder, based on 100 parts by weight of pigment.

As a binder, in particular the mixture is used together with starch. The proportion of starch may be from 1 to 99, particularly preferably from 10 to 90, very particularly preferably from 30 to 80, % by weight, based on the total weight of mixture and starch.

The paper coating slip can be prepared by conventional methods. Preferably, the mixture of A) and B) is prepared separately beforehand and only thereafter added to the paper coating slip, i.e. mixed with the further components, such as pigment and starch.

By using the novel mixture of A) and B), incompatibilities with other binders, in particular starch, are avoided or reduced.

Incompatibilities due to the presence of paper coating slip which has been worked up again are also reduced or avoided.

During the coating process, paper coating slip occurs as waste. This waste is-generally worked up again, in particular by filtration or ultrafiltration, and is reused in amounts of, preferably, from 0.5 to 15, in particular from 1 to 10, % by weight, based on the total paper coating slip (solid, i.e. without water).

### EXAMPLES

### Example 1

### Preparation of a Polymer Dispersion (Polymer A)

234 g of water, 15 g of a 33% strength by weight polymer seed (polystyrene latex, particle size from about 30 to 35 nm), 0.6 g of a 45% strength by weight solution of the sodium salt of disulfonated monododecyidiphenyl ether (Dowfax 2A1, Dow Chemical) and 10% of the initiator solution (feed 2) were initially taken in a polymerization vessel and heated to 95° C. with stirring.

The monomer emulsion (feed 1) and the remaining amount of the initiator solution were then added to the polymerization vessel by two separate feeds, beginning simultaneously, in the course of 4 hours, while maintaining the temperature. After the end of the monomer addition, the temperature was maintained at 95° C. for a further hour, after which cooling at room temperature was effected. 23 g of a 10% strength by weight sodium hydroxide solution were then added.

Feed 1:

273 g of styrene

198.5 g of butadiene

176 g of demineralized water

24.8 g of an aqueous, 50% strength by weight acrylamide solution

13.2 g of an aqueous, 15% strength by weight sodium dodecylsulfate solution

12.4 g of acrylic acid

7.4 g of tert-dodecyl mercaptan

4.4 g of an aqueous 45% strength by weight solution of the sodium salt of disulfonated monodecyl diphenyl ether (DOWFAX 2A1, Dow Chemical)

2 g of an aqueous, 25% strength by weight sodium hydroxide solution

Feed 2:

59 g of an aqueous, 10% strength by weight sodium persulfate solution

The solids content of the dispersion was 50% by weight. The light transmittance was 60%. The weight average particle size D50 was 140 nm. The pH was 6.1 and the glass transition temperature Tg was 6° C.

### Example 2

### Mixing of the Polymer Dispersion A) with Polymer B)

10 g of a 45% strength aqueous solution of a sodium polyacrylate having a number average molecular weight of 1 800 (Polysalz S from BASF) were added to a dispersion according to example 1 with slow stirring in the course of 1 minute.

The solids content of the dispersion was 50% by weight. The light transmittance was 60%. The weight average particle size D50 was 140 nm. The pH was 6.6 and the glass transition temperature Tg was 6° C.

### Example 3

A paper coating slip was prepared from 100 parts by weight (solid) of pigment (Hydrocarb 60, Omya AG, Switzerland), 8.4 parts by weight (solid) of cereal starch (Raisamyl 02033 LO, Raisio Chemicals Finland) and 9.5 parts by weight (solid) of the dispersion from example 1. The solids content of the coating slip was brought to 65.8% by weight with water. The pH of the slip was brought to 8.3 by means of a 10% by weight NaOH solution (coating slip 1).

A further paper coating slip was prepared from 100 parts by weight (solid) of pigment (Hydrocarb 60 Omya AG, Switzerland), 8.4 parts by weight (solid) of starch (Raisamyl 02033 LO, Raisio Chemicals Finland), and 9.5 parts by weight (solid) of the dispersion from example 2. The solids content of the coating slip was brought to 65.7% by weight with water. The pH of the slip was brought to 8.3 by means of a 10% by weight NaOH solution (coating slip 2).

The Brookfield viscosity of both coating slips was measured using spindle 4 at 25° C., both immediately and after storage for 24 hours at 25° C.:

| | Coating slip 1 | Coating slip 2 |
|---|---|---|
| Brookfield viscosity at 100 rpm | 1 330 mPa · s | 1 070 mPa · s |
| immediately | | |
| Brookfield viscosity at 100 rpm | 1 630 mPa · s | 1 190 mPa · s |
| after 24 hours | | |

### Example 4

A paper coating slip was prepared from 95 parts by weight (solid) of pigment (Hydrocarb 60, Omya AG, Switzerland) plus 5 parts by weight (solid) of filtered coating slip (paper coating slip which had been worked up again), 8 parts by weight (solid) of starch (Raisamyl 02033 LO, Raisio Chemicals Finland) and 9 parts by weight (solid) of the dispersion from example 1. The solids content of the coating slip was brought to 61.4% by weight with water. The pH of the slip was brought to 8.3 by means of a 10% by weight NaOH solution (coating slip 3).

A further paper coating slip was prepared from 95 parts by weight (solid) of pigment (Hydrocarb 60 Omya AG, Switzerland) plus 5 parts by weight (solid) of ultrafiltered coating slip (UF slip), 8 parts by weight (solid) of starch (Raisamyl 02033 LO, Raisio Chemicals Finland) and 9 parts by weight (solid) of the dispersion from example 2. The solids content of the coating slip was brought to 61.4% by weight with water. The pH of the slip was brought to 8.3 by means of a 10% by weight NaOH solution (coating slip 4).

The Brookfield viscosity of both coating slips was measured using spindle 4 at 25° C., both immediately and after storage for 24 hours at 25° C.:

| | Coating slip 3 | Coating slip 4 |
|---|---|---|
| Brookfield viscosity at 100 rpm | 1 280 mPa · s | 840 mPa · s |
| immediately | | |
| Brookfield viscosity at 100 rpm | 1 580 mPa · s | 975 mPa · s |
| after 24 hours | | |

### Example 5

A paper coating slip was prepared from 100 parts by weight (solid) of pigment (Hydrocarb 90, Omya AG, Switzerland), 8 parts by weight (solid) of potato starch (Raisamyl 304 ESP, Raisio Chemicals Finland) and 9 parts by weight (solid) of the dispersion from example 1. The solids content of the coating slip was brought to 59.9% by weight with water. The pH of the slip was brought to 8.4 by means of a 10% by weight NaOH solution (coating slip 5).

A further paper coating slip was prepared from 100 parts by weight (solid) of pigment (Hydrocarb 90 Omya AG, Switzerland), 8 parts by weight (solid) of starch (Raisamyl 304 ESP, Raisio Chemicals Finland) and 9 parts by weight (solid) of the dispersion from example 2. The solids content of the coating slip was brought to 60.0% by weight with water. The pH of the slip was brought to 8.6 by means of a 10% by weight NaOH solution (coating slip 6).

The Brookfield viscosity of both coating slips was measured using spindle 4 at 25° C., both immediately and after storage for 24 hours at 25° C.:

| | Coating slip 5 | Coating slip 6 |
|---|---|---|
| Brookfield viscosity at 100 rpm | 1 740 mPa · s | 1 460 mPa · s |
| immediately | | |
| Brookfield viscosity at 100 rpm | 1 360 mPa · s | 1 290 mPa · s |
| after 24 hours | | |

1-13. (canceled)

14. A paper coating slip comprising
A) an aqueous polymer dispersion (emulsion polymer) obtained by emulsion polymerization and
B) a polymer which is soluble in water (at 20° C., 1 bar), obtained by free radical polymerization and composed of at least 5% by weight of ethylenically unsaturated acids.

15. The paper coating slip as claimed in claim 14, wherein the emulsion polymer comprises at least 40% by weight of main monomers selected from C₁ to C₂₀-alkyl (meth)acrylates, vinyl esters of carboxylic acids of up to 20 carbon atoms, vinylaromatics of up to 20 carbon atoms, ethylenically unsaturated nitrites, vinyl halides, vinyl ethers of alcohols of 1 to 10 carbon atoms, and aliphatic hydrocarbons having 2 to 8 carbon atoms and one or two double bonds, or a mixture of these monomers.

16. The paper coating clip as claimed in claim 14, wherein the emulsion polymer comprises at least 60% by weight of butadiene or a mixture of butadiene and styrene.

17. The paper coating slip as claimed in claim 14, wherein polymer B) comprises at least 30% by weight of an ethylenically unsaturated carboxylic acid, acrylic acid or methacrylic acid.

18. The paper coating slip as claimed in claim 14, wherein polymer B) is added to the emulsion polymer before, during or after the emulsion polymerization.

19. The paper coating slip as claimed in claim 14, wherein the amount of polymer B) is from 0.01 to 10 parts by weight per 100 parts by weight of emulsion polymer A).

20. The paper coating slip as claimed in claim 14, wherein the paper coating slip comprises starch.

21. The paper coating slip as claimed in claim 14, wherein the paper coating slip comprises at least 2% by weight of a paper coating slip which has occurred as a waste in the coating process.

22. A method of manufacturing a paper coat slip comprising mixing the paper coat slip as claimed in claim 14 with at least one additional paper coating slip component.

23. The method as claimed in claim 22, wherein the at least one additional paper coating slip component is starch.

24. The method as claimed in claim 22 wherein the at least one additional paper coating slip component is at least one selected from the group consisting of a binder, a thickener, a pigment, a filler, a fluorescent dye, a phosphorescent dye, a dye, an optical brightener and a leveling agent.

25. The paper coating slip as claimed in claim 21, wherein the paper coating slip comprises starch.

26. A paper coated with the paper coat slip as claimed in claim 14.
